(19) United States
(12) Patent Application Publication
(10) Pub. No.: US 2021/0258405 A1
(43) Pub. Date: Aug. 19, 2021

(54) SWIFT CONTENT DOWNLOAD USING SMART LINK AGGREGATION

(71) Applicant: QUALCOMM Incorporated, San Diego, CA (US)

(72) Inventors: Ajit CHOURASIA, San Diego, CA (US); Jaikanth KRISHNASWAMY, San Diego, CA (US); Rasjinder SINGH, San Diego, CA (US); Vijaya Datta MAYYURI, San Diego, CA (US); Songan MAO, San Diego, CA (US)

(21) Appl. No.: 16/809,022

(22) Filed: Mar. 4, 2020

Related U.S. Application Data
(60) Provisional application No. 62/976,284, filed on Feb. 13, 2020.

(51) Int. Cl. H04L 29/06; H04L 29/08; H04L 12/26

(52) U.S. Cl. CPC H04L 69/166; H04L 67/02; H04L 67/141; H04L 67/108; H04L 43/0852; H04L 67/06

(57) ABSTRACT

Methods, systems, and devices are provided for supporting hypertext transfer protocol (HTTP) download of a content item by a computing device. Various embodiments may enable swift content download (SCD). Once SCD is triggered, the current request to the server may be closed. SCD partitions the content into fragments (e.g., byte ranges) spanning the entire file content, and then simultaneously requests the fragments individually over multiple HTTP requests in a multi-threaded framework leveraging multiple network connections and interfaces (e.g., WiFi and 3G/4G/5G).

### RELATED APPLICATIONS

This application claims the benefit of priority to U.S. Provisional Application No. 62/976,284 entitled “Swift Content Download Using Smart Link Aggregation” filed Feb. 13, 2020, the entire contents of which are hereby incorporated herein by reference for all purposes.

### BACKGROUND

Long Term Evolution (LTE), 5G new radio (NR), and other recently developed communication technologies allow wireless devices to communicate information at data rates (e.g., in terms of Gigabits per second, etc.) that are orders of magnitude greater than what was available just a few years ago.

Today's communication networks are also more secure, resilient to multipath fading, allow for lower network traffic latencies, provide better communication efficiencies (e.g., in terms of bits per second per unit of bandwidth used, etc.). These and other recent improvements have facilitated the emergence of the Internet of Things (IOT), large scale Machine to Machine (M2M) communication systems, autonomous vehicles, and other technologies that rely on consistent and secure communications.

### SUMMARY

Various aspects of the present disclosure include methods, systems, and devices for supporting hypertext transfer protocol (HTTP) download of a content item by a computing device. Various aspects may enable swift content download (SCD). In various embodiments, once SCD is triggered, the current request to the server is closed. In various aspects, SCD partitions the content into fragments (e.g., byte ranges) spanning the entire file content. In various aspects, SCD then simultaneously requests the fragments individually over multiple HTTP requests in a multi-threaded framework leveraging multiple network connections and interfaces (e.g., WiFi and 3G/4G/5G).

In various aspects, methods may be performed by a processor of a computing device, such as a user equipment (UE) computing device. Various aspects may include determining whether an HTTP response received from a server indicates that the server supports HTTP range requests and a content length of a content item to be downloaded is at, or above, a content length threshold, wherein the HTTP response is received from the server over an initial transmission control protocol (TCP) connection with the server and the HTTP response is in response to an HTTP request from an application sent to the server over the initial TCP connection, and, in response to determining that the HTTP response received from the server indicates that the server supports HTTP range requests and the content length of the content item to be downloaded is at, or above, the content length threshold, closing the initial TCP connection, establishing an input stream to the application, partitioning the content item to be downloaded into a series of fragments, wherein each of the series of fragments is a non-overlapping byte range of the content to be downloaded such that the series of fragments fully covers the content item to be downloaded and each of the series of fragments has a fragment size smaller than the content length of the content item to be downloaded, downloading the series of fragments from the server using HTTP range requests sent over TCP connections established via two or more different available interfaces with the server, and providing any received fragments of the content item to the input stream to the application.

Some aspects may further include downloading the content item to be downloaded over the initial TCP connection in response to determining that the HTTP response received from the server indicates that the server does not support HTTP range requests or the content length of the content item to be downloaded is below the content length threshold.

In some aspects downloading the series of fragments from the server using HTTP range requests sent over TCP connections established via two or more different available interfaces with the server may include generating an HTTP range request for each of the series of fragments, and sending the HTTP range requests in sequential fragment order over TCP connections established via two or more different available interfaces with the server. In some aspects, sending the HTTP range requests in sequential fragment order over TCP connections established via two or more different available interfaces with the server may include determining link rate estimates for each of the two or more different available interfaces with the server, apportioning assignment of the HTTP range requests among the TCP connections established via the two or more different available interfaces with the server based at least in part on the determined link rate estimates, and sending each of the HTTP range requests over its respective assigned TCP connection and corresponding one of the two or more different available interfaces to the server. In some aspects, generating the HTTP range request for each of the series of fragments may include generating the HTTP range request for each of the series of fragments in sequential fragment order.

Some aspects may further include determining whether memory resources are available for downloading a next fragment of the series of fragments, in which generating the HTTP range request for each of the series of fragments in sequential fragment order may include generating the HTTP range request for each of the series of fragments in sequential fragment order in response to determining that memory resources are available for downloading a next fragment of the series of fragments.

Some aspects may further include, for each download of a fragment of the series of fragments, determining whether a download time is longer than a delay threshold, canceling the HTTP range request of the fragment in response to determining that the download time is longer than the delay threshold, and assigning the HTTP range request of the fragment among the TCP connections established via the two or more different available interfaces with the server based at least in part on the determined link rate estimates in response to canceling the HTTP range request.

Some aspects may further include determining that all assigned HTTP range requests have completed download on one of the two or more different available interfaces, and in response to determining that all assigned HTTP range requests have completed download on one of the two or more different available interfaces, for each remaining download of a fragment of the series of fragments on the other of the two or more different available interfaces, determining whether a download time is longer than a delay threshold, canceling the HTTP range request of the fragment in response to determining that the download time is longer than the delay threshold, and assigning the HTTP range request of the fragment among the TCP connections established via the two or more different available interfaces with the server based at least in part on the determined link rate estimates in response to canceling the HTTP range request. In some aspects, the apportionment of assignments of the HTTP range requests among the TCP connections established via the two or more different available interfaces with the server based at least in part on the determined link rate may be a probabilistic distribution calculated based on the determined link rate.

In some aspects, providing any received fragments of the content item to the input stream to the application may include queuing any received fragments of the content item as fragments of the content item are received from the server, and providing queued fragments of the content item to the input stream in sequential fragment order. In some aspects, each of the two or more different available interfaces are different network connections established by the computing device. In some aspects, the two or more different available interfaces may include at least one Wi-Fi connection and at least one cellular connection.

Further aspects may include a wireless device having a processor configured to perform one or more operations of any of the methods summarized above. Further aspects may include a non-transitory processor-readable storage medium having stored thereon processor-executable instructions configured to cause a processor of a wireless device to perform operations of any of the methods summarized above. Further aspects include a wireless device having means for performing functions of any of the methods summarized above. Further aspects include a system on chip for use in a wireless device that includes a processor configured to perform one or more operations of any of the methods summarized above. Further aspects include a system in a package that includes two systems on chip for use in a wireless device that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram conceptually illustrating an example communications system.

FIG. 2 is a component block diagram illustrating a computing system that may be configured to implement various embodiments.

FIG. 3 is a diagram illustrating an example of a software architecture including a radio protocol stack for the user and control planes in wireless communications in accordance with various embodiments.

FIGS. 4A and 4B are block diagrams illustrating example computing device system architectures according to various embodiments.

FIG. 5 is a block diagram illustrating an example system architecture of a swift content download (SCD) module according to various embodiments.

FIG. 6 is a process flow diagram illustrating an embodiment method for supporting hypertext transfer protocol (HTTP) download of a content item by a computing device.

FIG. 7 is a process flow diagram illustrating an embodiment method for supporting hypertext transfer protocol (HTTP) download of a content item by a computing device.

FIG. 8 is a process flow diagram illustrating an embodiment method for downloading a series of fragments from a server using HTTP range requests sent over transmission control protocol (TCP) connections established via two or more different available interfaces with the server.

FIG. 9 is a process flow diagram illustrating an embodiment method for monitoring fragment downloads to mitigate head of line (HOL) blocking.

FIG. 10 is a process flow diagram illustrating an embodiment method for monitoring fragment downloads to mitigate trailing conditions.

FIG. 11 is a process flow diagram illustrating an embodiment method for providing any received fragments of a content item to an input stream to an application.

FIG. 12 is a call flow diagram illustrating example interactions between an application, HTTP client, SCD module, and server according to various embodiments.

FIG. 13 is a component block diagram of a computing device suitable for implementing various embodiments.

FIG. 14 is a component block diagram of a computing device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide methods that may support hypertext transfer protocol (HTTP) download of a content item by a computing device by enabling swift content download (SCD). In various embodiments, once SCD is triggered, the current request to the server is closed. SCD partitions the content into fragments (e.g., byte ranges) spanning the entire file content. SCD then simultaneously requests the fragments individually over multiple HTTP requests in a multi-threaded framework leveraging multiple network connections and interfaces (e.g., WiFi and 3G/4G/5G).

The main sources of downloadable content include app stores, video content providers, and gaming sites. Other content download use cases include downloads of firmware and artifacts that are not directly initiated by the user. A poor download experience can potentially impact the usability of applications and discourage users from using them. Various embodiments enable the SCD feature to reduce (e.g., minimize) content download latency and improve the mobile device user experience.

Typically, during a content downloads, a single transmission control protocol (TCP) session is set up between the source and the client. With a single interface, typically either a WiFi or cellular network connection, the channel condition and throughput of a single interface affects the overall content download time.

Various embodiments provide approaches to improve performance and provide robust data transfers using multiple network connections and interfaces (such as WiFi and 3G/4G/5G). The use of multiple interfaces may improve download performance with smart link aggregation (SLA) as multiple TCP sessions may be associated with the content download and may be distributed over multiple interfaces.

Various embodiments may leverage HTTP range requests, such as the HTTP/1.1 range requests defined in Internet Engineering Task Force (IETF) Request for Comments (RFC) 7233. The range request allows devices to download a portion of an HTTP message, leaving the remainder of that message to a subsequent request. Devices that have additional interfaces benefit from being able to request only a subset of a larger message over an interface.

Various embodiments may partition the content into fragments (byte ranges) spanning the entire file content, then simultaneously request the fragments individually over multiple HTTP requests in this multi-threaded framework. With SLA employed for managing the distribution of sockets, the subsequent download of the fragment may depend on the probabilistic distribution.

In addition, various embodiments may provide a Smart Accelerator Monitor (SMA) component. The SMA may be triggered to monitor particular fragment downloads when the head of line (HOL) blocking caused by unstable network conditions (where throughput of an interface is low, or a stall has occurred) is detected. This case arises when a socket is on an interface whose throughput has deteriorated. This socket happens to be for a fragment that is blocking the delivery of other downloaded fragments.

Detection of HOL blocking is a function of the number of fragments that are downloaded but not consumed by the user. In such a case, the SMA may measure the time that is taken (thus far) in downloading the HOL blocking fragment, based on a configurable threshold, close all existing requests whose time consumed is greater than the threshold, and restart the fragment downloads, carrying forward data already downloaded for the fragment.

Similarly, the SMA may also manage a trailing condition. A trailing condition is when there are available threads and no additional fragments need to be downloaded. When a trailing condition is detected all existing requests whose time consumed is greater than the threshold may be closed and restarted as is done in the HOL blocking case.

In addition, the SMA continuously monitors for conditions in which both the HOL and trailing conditions are not met and forces a restart of the existing requests whose time consumed is greater than the threshold. All of these SMA monitoring operations may happen seamlessly from the user perspective.

In an ideal condition where two or more links are performing well, various embodiments may provide significant benefits in terms of faster downloads.

The term “wireless device” and “user equipment (UE) computing device” used herein to refer to any one or all of wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

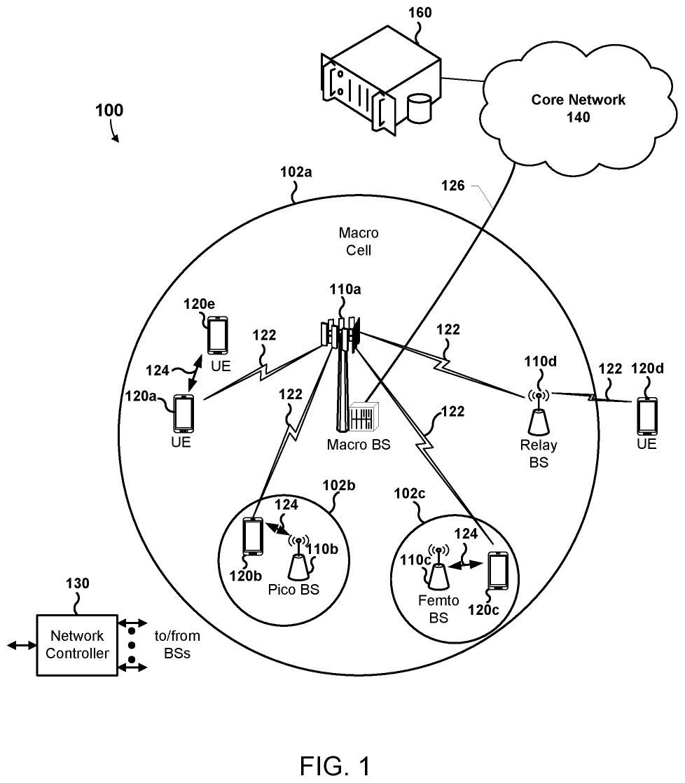

FIG. 1 illustrates an example of a communications system 100 that is suitable for implementing various embodiments. The communications system 100 may be an 5G NR network, or any other suitable network such as an LTE network.

The communications system 100 may include a heterogeneous network architecture that includes a core network 140 and a variety of mobile devices (also referred to as user equipment (UE) computing devices) (illustrated as wireless device 120a-120e in FIG. 1). The communications system 100 may also include a number of base stations (illustrated as the BS 110a, the BS 110b, the BS 110c, and the BS 110d) and other network entities. A base station is an entity that communicates with wireless devices (mobile devices or UE computing devices), and also may be referred to as an NodeB, a Node B, an LTE evolved nodeB (eNB), an Access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

The communications system 100 may also include one or more servers 160 connected to the core network 140. The one or more servers 160 may servers storing content items that may be made available to the devices in the communications system 100 via the core network 140 and various connections in the communications system 100. For example, the one or more servers 160 may be content servers, web servers, etc. As a specific example, mobile devices (e.g., UE computing devices) (illustrated as wireless device 120a-120e in FIG. 1) may establish TCP connections via various interfaces in the communications system 100 to enable HTTP download (e.g., HTTP or secure HTTP (HTTPS) download) of content items from the one or more servers 160. The one or more servers 160 may support content downloads, such as media files, firmware, applications, game updates, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted Access by mobile devices with service subscription. A pico cell may cover a relatively small geographic area and may allow unrestricted Access by mobile devices with service subscription. A femto cell may cover a relatively small geographic area (for example, an Home) and may allow restricted access by mobile devices having association with the femto cell (for example, mobile devices in a closed subscriber group (CSG)). A base station for a macro cell may be referred to as a macro BS. A base station for a pico cell may be referred to as a pico BS. A base station for a femto cell may be referred to as a femto BS or an Home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120e (UE computing device) may communicate with the base station 110a-110d over a wireless communication link 122.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110d). A relay station is an entity that can receive a transmission of data from an upstream station (for example, a base station or a mobile device) and send a transmission of the data to a downstream station (for example, a wireless device or a base station). A relay station also may be a mobile device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be an Heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have an High transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices (UE computing devices) 120a, 120b, 120c may be dispersed throughout communications system 100, and each wireless device may be stationary or mobile. A wireless device also may be referred to as an Access terminal, a UE, a terminal, a mobile station, a subscriber unit, a station, etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122, 124 may include a plurality of carrier signals, frequencies, or frequency bands, each of which may include a plurality of logical channels. The wireless communication links 122 and 124 may utilize one or more radio Access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links 122, 124 within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some embodiments may use terminology and examples associated with LTE technologies, various embodiments may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL Control data. Beamforming may be supported and beam direction may be dynamically configured. Multiple Input Multiple Output (MIMO) transmissions with precoding may also be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

Some mobile devices may be considered machine-type communication (MTC) or evolved or enhanced machine-type communication (eMTC) mobile devices. MTC and eMTC mobile devices include, for example, robots, drones, remote devices, sensors, meters, monitors, location tags, etc., that may communicate with a base station, another device (for example, remote device), or some other entity. A wireless node may provide, for example, connectivity for or to a network (for example, a wide area network such as Internet or a cellular network) via a wired or wireless communication link. Some mobile devices may be considered Internet-of-Things (IoT) devices or may be implemented as NB-IoT (narrowband internet of things) devices. A wireless device 120a-e may be included inside an Housing that houses components of the wireless device, such as processor components, memory components, similar components, or a combination thereof.

In general, any number of communications systems and any number of wireless networks may be deployed in a given geographic area. Each communications system and wireless network may support a particular radio Access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, NR or 5G RAT networks may be deployed.

In some implementations, two or more mobile devices 120a-e (for example, illustrated as the wireless device 120a and the wireless device 120e) may communicate directly using one or more sidelink channels 124 (for example, without using a base station 110a-110d as an intermediary to communicate with one another). For example, the wireless devices 120a-e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-e may perform scheduling operations, resource selection operations, as well as other operations described elsewhere herein as being performed by the base station 110a

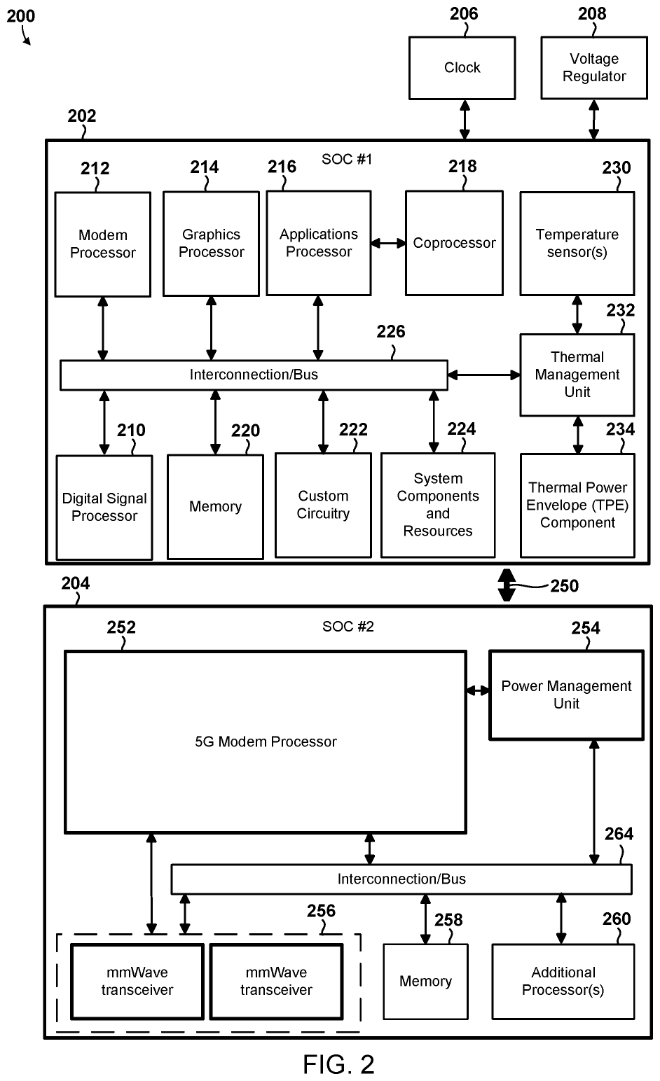

Various embodiments may be implemented on a number of single processor and multiprocessor computer systems, including a system-on-chip (SOC) or system in a package (SIP). FIG. 2 illustrates an example computing system or SIP 200 architecture that may be used in wireless devices (UE computing devices) implementing the various embodiments.

With reference to FIGS. 1 and 2, the illustrated example SIP 200 includes a two SOCs 202, 204, a clock 206, and a voltage regulator 208. In some embodiments, the first SOC 202 operate as central processing unit (CPU) of the wireless device that carries out the instructions of software application programs by performing the arithmetic, logical, Control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more temperature sensors 230, a thermal Management unit 232, and a thermal power envelope (TPE) component 234. The second SOC 204 may include a 5G modem processor 252, a power Management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, Access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal Management unit 232 via an interconnection/bus module 226. Similarly, the processor 252 may be interconnected to the power Management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

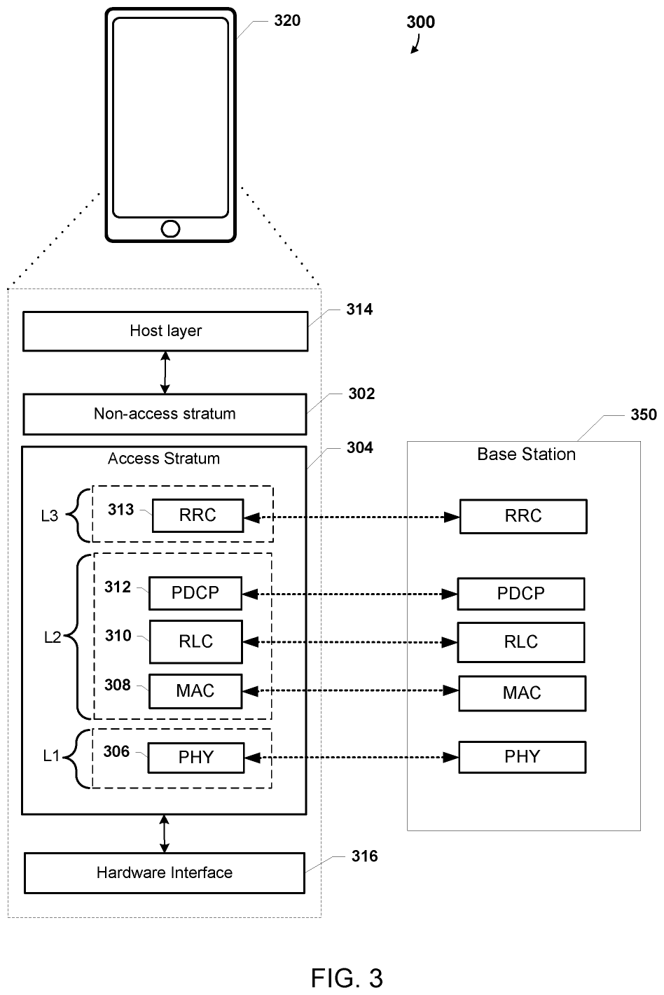

FIG. 3 illustrates an example of a software architecture 300 including a radio protocol stack for the user and control planes in wireless communications between a base station 350 (e.g., the base station 110a) and a wireless device (UE computing device) 320 (e.g., the wireless device 120a-120e, 200). With reference to FIGS. 1-3, the wireless device 320 may implement the software architecture 300 to communicate with the base station 350 of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security Management, Mobility Control, Session Management, and traffic and signaling between a SIM(s) of the wireless device (e.g., SIM(s) 204) and its core network 140. The AS 304 may include functions and protocols that support communication between a SIM(s) (e.g., SIM(s) 204) and entities of supported Access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface. Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In the various embodiments, Layer 2 may include a media Access Control (MAC) sublayer 308, a radio link control (RLC) sublayer 310, and a packet data convergence protocol (PDCP) 312 sublayer, each of which form logical connections terminating at the base station 350.

In the Control plane, Layer 3 (L3) of the AS 304 may include a radio resource control (RRC) sublayer 3. While not shown, the software architecture 300 may include additional Layer 3 sublayers, as well as various upper layers above Layer 3. In various embodiments, the RRC sublayer 313 may provide functions including broadcasting system information, paging, and establishing and releasing an RRC signaling connection between the wireless device 320 and the base station 350.

In various embodiments, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random Access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some embodiments, application-specific functions provided by the at least one host layer 314 may provide an interface between the software architecture and the general purpose processor 206.

In other embodiments, the software architecture 300 may include one or more higher logical layer (e.g., transport, Session, presentation, application, etc.) that provide host layer functions. For example, in some embodiments, the software architecture 300 may include a network layer (e.g., Internet Protocol (IP) layer) in which a logical connection terminates at a packet data network (PDN) gateway (PGW). In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more radio frequency (RF) transceivers).

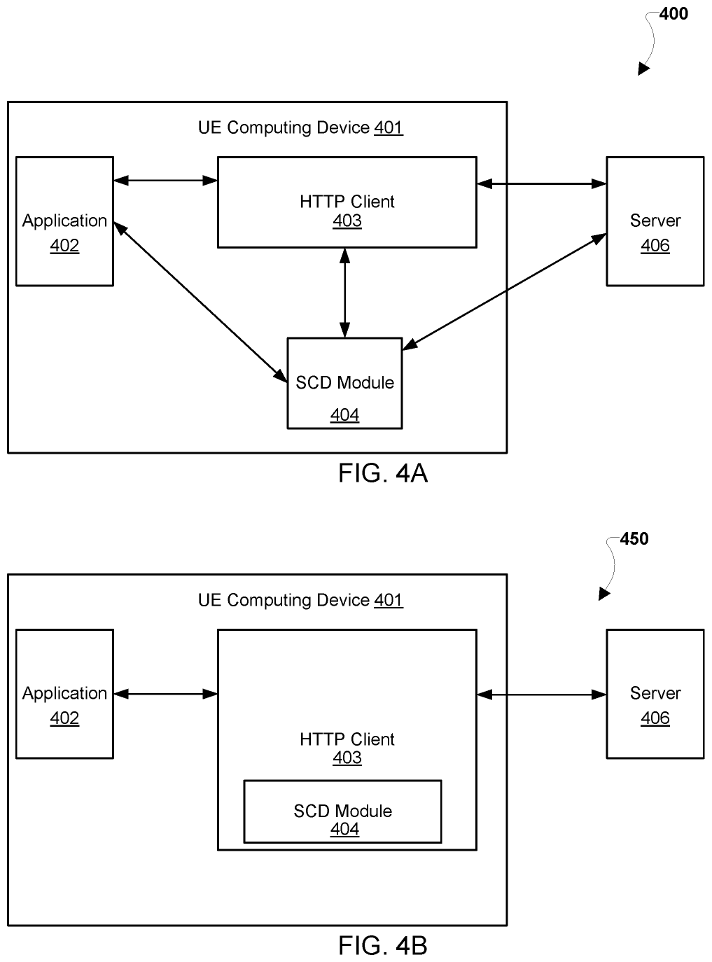

FIG. 4A illustrates an example system 400 according to various embodiments. FIG. 4B illustrates another example system 450 according to various embodiments. With reference to FIGS. 1-4B, the systems 400 and 450 may include a UE computing device 401 (e.g., the wireless device 120a-120e, 200, 320) in communication with a server 406 (e.g., the server 160). The UE computing device 401 may include an application 402, such as a gaming application, media application, etc., that requests content downloads, such as media files, firmware, applications, game updates, etc., from the server 406 via the HTTP client 403. The UE computing device 401 may be configured by machine-executable instructions. Machine-executable instructions may include one or more instruction modules. The instruction modules may include computer program modules. The instruction modules may include one or more of an application 402, a HTTP client 403, and a SCD module 404. Processor(s) of the UE computing device 401 may be configured to execute modules 402, 403, and/or 404, and/or other modules by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

In a typical content download scenario, the application 401 sends a HTTP/HTTPS request to the server 406. Once the server 406 receives the request, the server 406 begins transmitting data over a TCP connection to the application 402 via the HTTP client 403. As an example, the HTTP client 403 may be the OKHTTP client used by the Android Open Source Project (AOSP) and may perform the actual HTTP/HTTPS transactions. This generally happens over a single TCP connection.

In various embodiments, a swift content download (SCD) module 404 may be included in the UE computing device 401. The SCD module 404 may be a stand alone module running on a processor of the UE computing device 401 as illustrated in the architecture of system 400 of FIG. 4A or may be a sub-module of the HTTP client 403 as illustrated in the architecture of system 450 of FIG. 4B. The SCD module 404 may generate HTTP/1.1 range requests as defined in IETF RFC 7233. The range request allows devices to download a portion of an HTTP message, leaving the remainder of that message to a subsequent request. Devices that have additional interfaces benefit from being able to request only a subset of a larger message. This requires the server 406 to support HTTP range requests. In various embodiments, a decision to trigger the SCD module 404 may be made based on the server 406 capability to support HTTP range requests and the content length to be downloaded. In various embodiments, the SCD module 404 may have a configurable content length threshold. Once a decision is made to trigger the SCD module, the current request to the server 406 may be closed and the SCD module 404 may be engaged. In various embodiments, the SCD module 404 partitions the content into fragments (byte ranges) spanning the entire file content. The SCD module 404 may then simultaneously request the fragments individually over multiple HTTP requests in a multi-threaded framework.

In various embodiments, the SCD module 404 may be radio access technology (RAT) agnostic. The SCD module 404 may use smart link aggregation (SLA) to establish different TCP connections over two or more different available interfaces with the server 406. SLA may enable the SCD module 404 to leverage all available interfaces based at least in part on link rate estimates (LREs). The distribution of multiple TCP sessions originating from the SCD module 404 over multiple interfaces may be managed by SLA. For example, the SCD module 404 may apportion assignment of HTTP requests among the TCP connections established via different available interfaces with the server 406 by a probabilistic distribution calculated based on the determined link rate. The SCD module 404 employing SLA may improve user experience by adaptively aggregating capacity across available interfaces and distributing TCP sessions across those available interfaces

In various embodiments, when the application 402 sends a request to download a file (e.g., content item), the HTTP client 403 may initially open a TCP session (e.g., an initial TCP connection) to retrieve the file content length and verify if the range request is supported by the server 406. Based on file content length being long enough and support for range requests from the server 406, the SCD module 404 may be engaged. The HTTP client 403 may close the current connection (e.g., the initial TCP connection) and then hand over the request to the SCD module 404 to download the file. As an example, the HTTP client 403 may send a SCD request to the SCD module 404 indicating the content length, the server 406 address, and an identifier of the application 402. The SCD module 404 may make multiple HTTP/HTTPS range requests simultaneously. These individual HTTP/HTTPS requests can go over any of the available interfaces as determined by the SLA distribution. From an application 402 perspective the transition from download being handled by the HTTP client 403 to being handled by the SCD module 404 may be seamless. The application 402 may receive an HTTP response with an input stream from the SCD module 404 that may be identical to what would have been received if the HTTP client 403 had handled download.

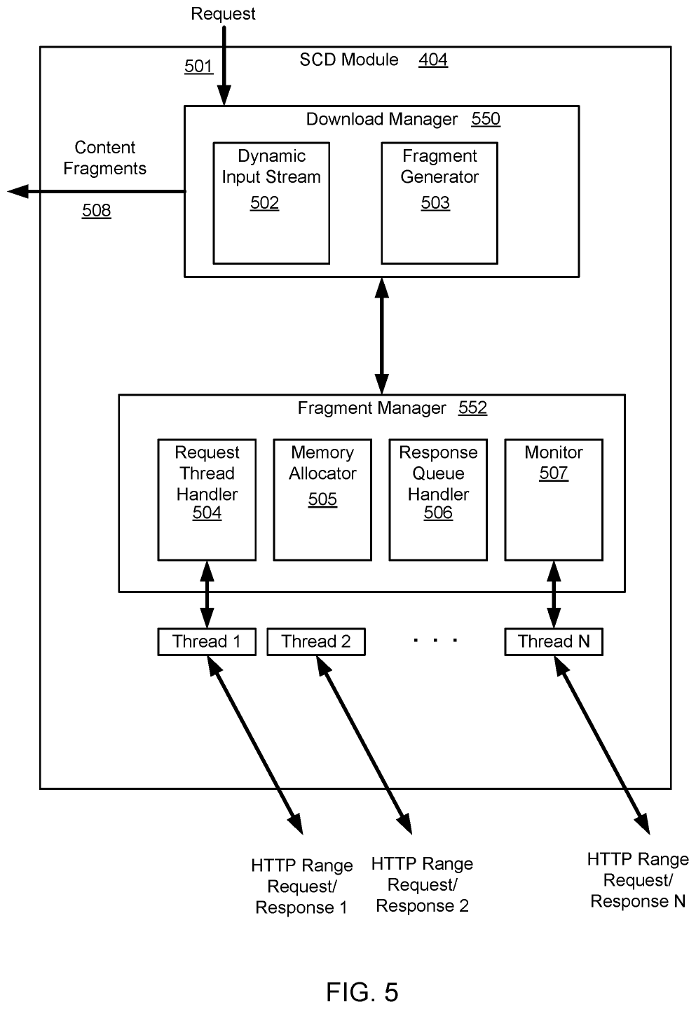

FIG. 5 illustrates an example swift content download (SCD) module 404 according to various embodiments. With reference to FIGS. 1-5, the SCD module 404 may include a download manager 550 including a dynamic input stream 502 and a fragment generator 503. The download manager 550 may interface with a fragment manager 552 of the SCD module 404. The fragment manager 552 may include a request thread handler 504, a memory allocator 505, a response queue handler 506, and a monitor 507. The UE computing device 401 may be configured by machine-executable instructions. Machine-executable instructions may include one or more instruction modules. The instruction modules may include computer program modules. The instruction modules may include one or more of a download manager 550, a dynamic input stream 502, a fragment generator 503, a fragment manager 552, a request thread handler 504, a memory allocator 505, a response queue handler 506, and a monitor 507. Processor(s) of the UE computing device 401 may be configured to execute modules 550, 502, 503, 552, 504, 505, 506, and/or 507, and/or other modules by software; hardware; firmware; some combination of software, hardware, and/or firmware; and/or other mechanisms for configuring processing capabilities on processor(s).

The primary purpose of SCD module 404 may be to leverage the range request capability and subsequently use SLA for distributing the multiple requests across the available interfaces of the UE computing device 401. Once the HTTP client 403 triggers the SCD module 404, SCD module 404 may take over handling of the HTTP request from the HTTP client 403. For example, the SCD module 404 may be triggered by a request 501 received from the HTTP client 403. As an example, the request 501 may be a SCD request to the SCD module 404 indicating the content length, the server 406 address, and an identifier of the application 402. The SCD module 404 may provide an HTTP/HTTPS response with an input stream to the application 402. The input stream may enable content fragments 508 to be provisioned to the application 402. When downloading the file, SCD module 404 may partition the file content into smaller fragment sizes. The SCD module 404 may start placing HTTP/HTTPS requests to download the content fragments. The requests may be allocated memory, as threads, such as thread 1, 2, . . . n, are spawned for individual content fragments. When the responses arrive from the server 406, the content fragments in the response are queued in sequence and pushed to the dynamic input stream 502 for provisioning to the application 402. The input stream may be continuously updated as data from the various fragment requests arrive. The application 402 may be agnostic to the method used to download the fragments.

The SCD module 404 may internally include a download manager 550 and a fragment manager 552.

When the HTTP client 403 initially hands over the request to the SCD module 404, the application 402 may be expecting a response and an input stream to be made available to read the downloaded data. The download manager 550 may be the component that is responsible for providing the response and the input stream. In addition, the download manager 550 may be responsible for delegating the fragment creation to the fragment generator 503.

The dynamic input stream 502 may be responsible for providing the downloaded fragment to the application 402. Typically, an application 402 reads the input stream and expects the data in sequence. The application 402 may receive content sequentially through the dynamic input stream 502.

The fragment generator 503 may be responsible for creating various fragments based on a configurable fragment size and providing the fragments to the fragment manager 552. The fragment size may be fixed for a download session. The fragment size may be a configurable parameter.

The fragment manager 552 may control the creation of the request thread handler 504 and the response queue handler 506. The download manager 550 may interface with the fragment manager 552 to initiate the HTTP/HTTPS range requests. The fragment manager 552 may also have a monitoring component, such as monitor 507, that allows monitoring of stalled downloads and trickle conditions that may occur in unstable channel conditions.

The request thread handler 504 may be responsible for creating the threads, such as threads 1, 2, . . . . N, etc., which are assigned the task for downloading each of the fragments. The number of threads may be fixed for a download session. The number of threads may be a configurable parameter. Each thread places individual HTTP/HTTPS range requests for the fragments it is assigned, such as one fragment (e.g., one byte range) per request. The HTTP responses received from the server 406 may be given to the response queue handler 506. The amount of memory available during runtime may be limited. As such, it may not be possible to spawn new threads to download fragments due to memory constraints. This lack of available memory may cause a blocking condition during runtime. In such an event, the thread waits for a configurable amount of time before again requesting allocation of memory to download the fragment. The total amount of memory available for fetching content can be restricted to a percentage of the total memory available. This total amount of memory available for fetching content may be a configurable parameter.

The memory allocator 505 may be responsible for managing memory for the thread fragment requests. As new requests are placed for the fragments, the memory allocator 505 requests memory and handles out of memory concerns. The priority of getting the memory allocated may be based on fragment position in the overall file being downloaded.

The response queue handler 506 may handle all HTTP/HTTPS responses from the request thread handler. Once an HTTP/HTTPS is complete, it is queued in sequence of fragment numbers. The responses may arrive out of order even if the request placed by the request thread handler 504 is in byte-range order. The response queue handler 506 may be responsible for storing the downloaded fragments, and sequentially pushing them back to the dynamic input stream 502.

The monitor 507 may be triggered by the fragment manager 552 to monitor particular fragment downloads when head of line (HOL) blocking caused by unstable network conditions (where throughput of an interface is low, or a stall has occurred) is detected. This case arises when a socket is on an interface whose throughput has deteriorated. Detection of HOL blocking is a function of the number of fragments that are downloaded but not consumed by the application 402. In such a case, the monitor 507 measures the time taken (thus far) in downloading the HOL blocking fragment, based on a configurable threshold, closes all the existing requests whose time consumed is greater than the threshold, and restarts the fragment downloads, carrying forward data already downloaded for the fragment. A trailing condition is when there are available threads and no additional fragments need to be downloaded. When a trailing condition is detected all existing requests whose time consumed is greater than the threshold are closed and restarted as in the HOL blocking case. In addition, the monitor 507 continuously monitors in case both the above conditions are not met and forces a restart of the existing requests whose time consumed is greater than the threshold. With SLA managing the distribution of sockets, the subsequent download of the fragment may be dependent on the probabilistic distribution calculated based on LRE. The LRE may reflect the unstable network environment.

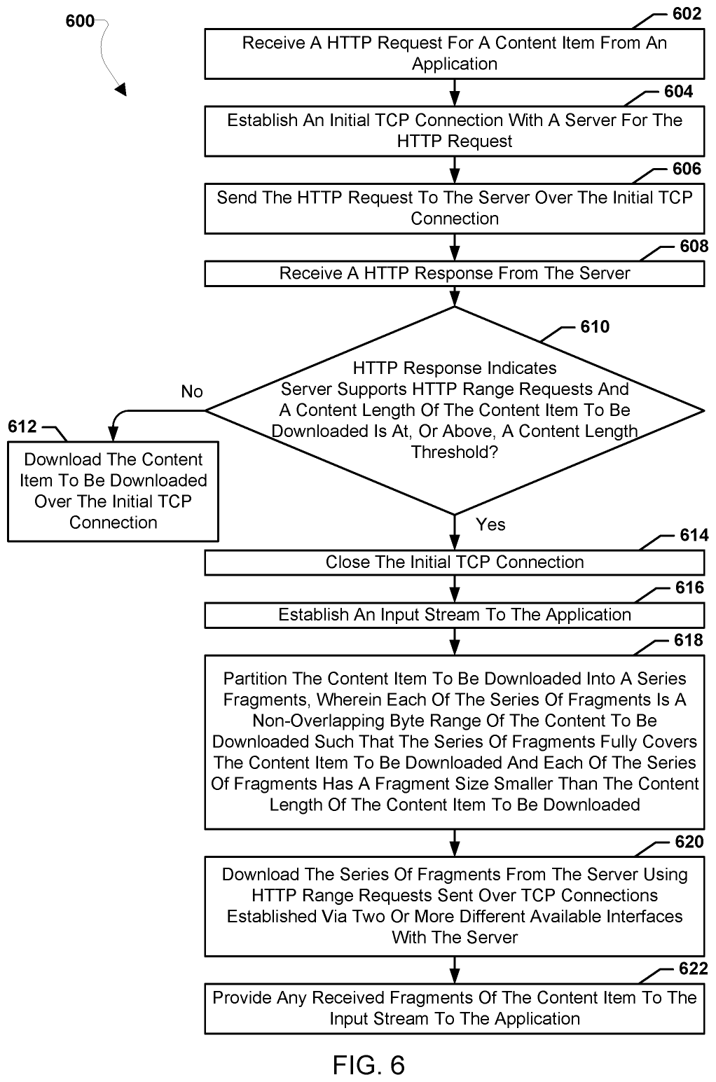

FIGS. 6-11 are process flow diagrams illustrating methods for supporting hypertext transfer protocol (HTTP) download of a content item by a computing device (e.g., the wireless device 120a-120e, 200, 320, the UE computing device 401, etc.) according to various embodiments. With reference to FIGS. 1-11, the operations of the methods illustrated in FIGS. 6-11 are intended to be illustrative. In some embodiments, methods may be accomplished with one or more additional operations not described, and/or without one or more of the operations discussed. Additionally, the order in which the operations of methods as illustrated in FIGS. 6-11 and described below is not intended to be limiting.

The methods illustrated in FIGS. 6-11 may be implemented in one or more processing devices, such as a digital processor, an analog processor, a digital circuit designed to process information, an analog circuit designed to process information, a state machine, and/or other mechanisms for electronically processing information. The one or more processing devices may include one or more devices executing some or all of the operations of the methods illustrated in FIGS. 6-11 in response to instructions stored electronically on an electronic storage medium. The one or more processing devices may include one or more devices configured through hardware, firmware, and/or software to be specifically designed for execution of one or more of the operations of the methods illustrated in FIGS. 6-11. For example, the operations of the methods illustrated in FIGS. 6-11 may be performed by a processor of a computing device (e.g., the wireless device 120a-120e, 200, 320, the UE computing device 401, etc.).

FIG. 6 illustrates an embodiment method 600 for supporting hypertext transfer protocol (HTTP) download of a content item by a computing device (e.g., the wireless device 120a-120e, 200, 320, the UE computing device 401, etc.). In various embodiments, one or more operations of the method 600 may be performed by an HTTP client (e.g., HTTP client 403) and/or a SCD module (e.g., SCD module 404).

In block 602, the computing device may receive a HTTP request for a content item from an application. For example, the HTTP client (e.g., 403) may receive a HTTP request for a content item from an application. The HTTP request may be a HTTP request or a HTTPS request. The content item may be a content item stored at a location remote from the computing device, such as a server (e.g., 160, 406).

In block 604, the computing device may establish an initial TCP connection with a server (e.g., 160, 406) for the HTTP request. For example, the HTTP client (e.g., 403) may establish an initial TCP connection with a server (e.g., 160, 406) for the HTTP request.

In block 606, the computing device may send the HTTP request to the server (e.g., 160, 406) over the initial connection. For example, the HTTP client (e.g., 403) may send the HTTP request to the server over the initial connection. The HTTP request may be sent as an HTTP request or a HTTPS request.

In block 608, the computing device may receive an HTTP response from the server (e.g., 160, 406). For example, the HTTP client (e.g., 403) may receive a HTTP response from the server. The HTTP response may indicate whether or not the server (e.g., 160, 406) supports HTTP range requests. The HTTP response may indicate the content length for the content item that was requested by the HTTP request.

In determination block 610, the computing device may determine whether the HTTP response received from the server (e.g., 160, 406) indicates that the server supports HTTP range requests and a content length of the content item to be downloaded is at, or above, a content length threshold. In this manner, the computing device may determine whether the HTTP response received from the server (e.g., 160, 406) indicates that the server supports HTTP range requests and a content length of the content item to be downloaded is at, or above, a content length threshold wherein the HTTP response is received from the server over an initial TCP connection with the server and the HTTP response is in response to an HTTP request from an application sent to the server over the initial TCP connection. As an example, the HTTP client 403 may determine whether the HTTP response received from the server (e.g., 160, 406) indicates that the server supports HTTP range requests and a content length of the content item to be downloaded is at, or above, a content length threshold. In various embodiments, the content length threshold may be a minimum size (e.g., a minimum number of bytes) above which a content item must be to result in SCD triggering.

In response to determining that the HTTP response received from the server indicates that the server does not support HTTP range requests or the content length of the content item to be downloaded is below the content length threshold (i.e., determination block 610=“No”), the computing device may download the content item to be downloaded over the initial TCP connection in block 612. For example, the HTTP client 403 may download the content item to be downloaded over the initial TCP connection in block 612.

In response to determining that the HTTP response received from the server indicates that the server supports HTTP range requests and the content length of the content item to be downloaded is at, or above, the content length threshold (i.e., determination block 610=“Yes”), the computing device may close the initial TCP connection in block 614. For example, the HTTP client 403 may close the initial TCP connection. Additionally, in response to determining that the HTTP response received from the server indicates that the server supports HTTP range requests and the content length of the content item to be downloaded is at, or above, the content length threshold (i.e., determination block 610=“Yes”), the computing device (e.g., the HTTP client) may send a SCD request to a SCD module (e.g., SCD module 404) to trigger the SCD module to handle download of the requested content in block 614. For example, the SCD request may indicate the content length, the server (e.g., 160, 406) address, and an identifier of the application (e.g., 402).

In block 616, the computing device may establish an input stream to the application (e.g., 402). For example, the SCD module 404 may establish an input stream to the application.

In block 618, the computing device may partition the content item to be downloaded into a series of fragments, in which each of the series of fragments is a non-overlapping byte range of the content to be downloaded such that the series of fragments fully covers the content item to be downloaded and each of the series of fragments has a fragment size smaller than the content length of the content item to be downloaded. For example, the SCD module 404 may partition the content item to be downloaded into a series of fragments, in which each of the series of fragments is a non-overlapping byte range of the content to be downloaded such that the series of fragments fully covers the content item to be downloaded and each of the series of fragments has a fragment size smaller than the content length of a content item to be downloaded.

In block 620, the computing device may download the series of fragments from the server (e.g., 160, 406) using HTTP range requests sent over TCP connections established via two or more different available interfaces with the server. As an example, the SCD module 404 may download the series of fragments from the server (e.g., 160, 406) using HTTP range requests sent over TCP connections established via two or more different available interfaces with the server. The HTTP range requests may be HTTP or HTTPS type requests. In various embodiments, each of the two or more different available interfaces may be different network connections established by the computing device. As examples, the two or more different available interfaces may include at least one Wi-Fi connection and at least one cellular connection (e.g., a 3G, 4G, and/or 5G connection).

In block 622, the computing device may provide any received fragments of the content item to the input stream to the application (e.g., application 402). For example, the SCD module 404 may provide any received fragments of the content item to the input stream to the application.

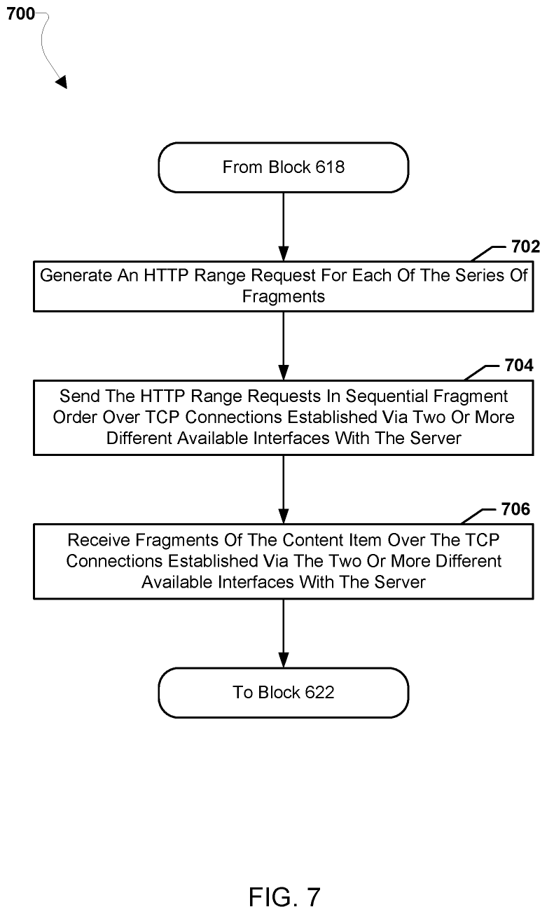

FIG. 7 illustrates an embodiment method 700 for supporting hypertext transfer protocol (HTTP) download of a content item by a computing device (e.g., the wireless device 120a-120e, 200, 320, the UE computing device 401, etc.). With reference to FIGS. 1-7, one or more operations of the method 700 may be performed by an HTTP client (e.g., 403) and/or a SCD module (e.g., 404), which are referred to generally as a computing device. In various embodiments, the operations of the method 700 may be performed in conjunction with the operations of the method 600. In some embodiments, the operations of the method 700 may be operations to download the series of fragments from the server using HTTP range requests sent over TCP connections established via two or more different available interfaces with the server performed in block 620 of the method 600.

In block 702, the computing device may generate an HTTP range request for each of the series of fragments. For example, the SCD module 404 may generate an HTTP range request for each of the series of fragments. In some embodiments, generating the HTTP range request for each of the series of fragments may include generating the HTTP range request for each of the series of fragments in sequential fragment order. In some embodiments, the computing device may determine whether memory resources are available for downloading a next fragment of the series of fragments and generating the HTTP range request for each of the series of fragments in sequential fragment order may include generating the HTTP range request for each of the series of fragments in sequential fragment order in response to determining that memory resources are available for downloading a next fragment of the series of fragments.

In block 704, the computing device may send the HTTP range requests in sequential fragment order over TCP connections established via two or more different available interfaces with the server (e.g., 160, 406). For example, the SCD module 404 may send the HTTP range requests in sequential fragment order over TCP connections established via two or more different available interfaces with the server.

In block 706, the computing device may receive fragments of the content item over the TCP connections established via the two or more different available interfaces with the server (e.g., 160, 406). For example, the SCD module 404 may receive fragments of the content item over the TCP connections established via the two or more different available interfaces with the server.

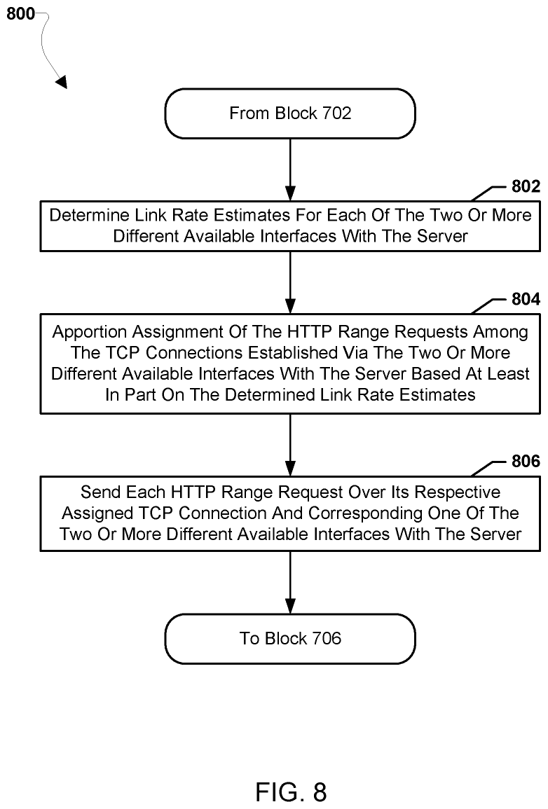

FIG. 8 illustrates an embodiment method 800 for downloading a series of fragments from a server (e.g., 160, 406) using HTTP range requests sent over TCP connections established via two or more different available interfaces with the server. With reference to FIGS. 1-8, one or more operations of the method 800 may be performed by an HTTP client (e.g., 403) and/or a SCD module (e.g., 404), which are referred to generally as a computing device. In various embodiments, the operations of the method 800 may be performed in conjunction with the operations of methods 600 and/or 700. In some embodiments, the operations of the method 800 may be operations to send the HTTP range requests in sequential fragment order over TCP connections established via two or more different available interfaces with the server performed in block 704 of the method 700.

In block 802, the computing device may determine link rate estimates (LREs) for each of the two or more different available interfaces with the server (e.g., 160, 406). For example, the SCD module 404 may determine link rate estimates for each of the two or more different available interfaces with the server.

In block 804, the computing device may apportion assignment of the HTTP range requests among the TCP connections established via the two or more different available interfaces with the server based at least in part on the determined link rate estimates. For example, the SCD module 404 may apportion assignment of the HTTP range requests among the TCP connections established via the two or more different available interfaces with the server based at least in part on the determined link rate estimates. In various embodiments, the apportionment of assignments of the HTTP range requests among the TCP connections established via the two or more different available interfaces with the server based at least in part on the determined link rate may be a probablisitic distribution calculated based on the determined link rate.

In block 806, the computing device may send each of the HTTP range requests over its respective assigned TCP connection and corresponding one of the two or more different available interfaces to the server (e.g., 106, 406). For example, the SCD module 404 may send each of the HTTP range requests over its respective assigned TCP connection and corresponding one of the two or more different available interfaces to the server.

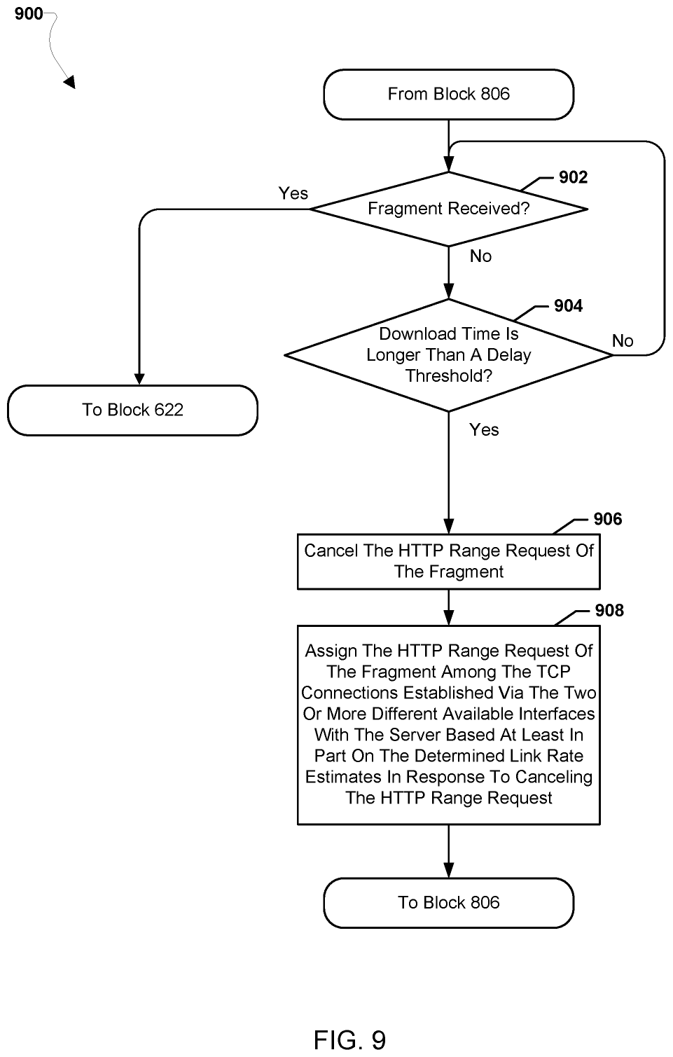

FIG. 9 illustrates an embodiment method 900 for monitoring fragment downloads to mitigate head of line (HOL) blocking. With reference to FIGS. 1-9, one or more operations of the method 900 may be performed by an HTTP client (e.g., 403) and/or a SCD module (e.g., 404), which are referred to generally as a computing device. In various embodiments, the operations of the method 900 may be performed in conjunction with the operations of methods 600, 700, and/or 800. In some embodiments, the operations of the method 900 may be operations performed for each download of a fragment of the series of fragments (e.g., operations performed on a per fragment basis).

In determination block 902, the computing device may determine whether a fragment is received. In response to determining that the fragment is received (i.e., determination block 902=“Yes”), the computing device may perform the operations in block 622 of the method 600.

In response to determining that the fragment is not received (i.e., determination block 902=“No”), the computing device may determine whether a download time is longer than a delay threshold in determination block 904. The download time may be the time that has passed since the thread for the fragment sent a HTTP range request for the fragment to a server (e.g., 160, 406). The delay threshold may be a configurable parameter, such as a number of milliseconds, seconds, etc.

In response to determining that the download time has not exceed the delay threshold (i.e., determination block 904=“No”), the computing device may determine whether the fragment is received in determination block 902.

In response to determining that the download time is longer than the delay threshold (i.e., determination block 904=“Yes”), the computing device may cancel the HTTP range request of the fragment in block 906.

In block 908, the computing device may assign the HTTP range request of the fragment among the TCP connections established via the two or more different available interfaces with the server (e.g., 160, 406) based at least in part on the determined link rate estimates in response to canceling the HTTP range request. In response to reassigning the fragment in block 908, the computing device may perform the operations in block 806.

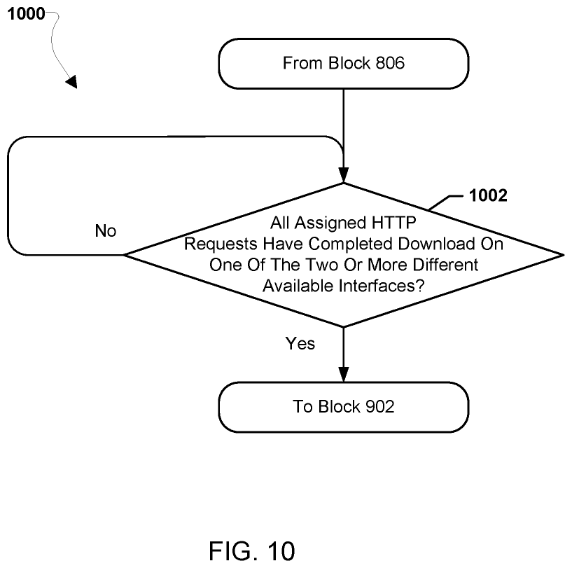

FIG. 10 illustrates an embodiment method 1000 for monitoring fragment downloads to mitigate trailing conditions. With reference to FIGS. 1-10, one or more operations of the method 1000 may be performed by an HTTP client (e.g., HTTP client 403) and/or a SCD module (e.g.), which are referred to generally as a computing device. In various embodiments, the operations of the method 1000 may be performed in conjunction with the operations of methods 600, 700, 800, 900, and/or 1000. In some embodiments, the operations of the method 1000 may be operations performed continually while any fragments of content are still awaiting provisioning to the application (e.g., application 402).

In determination block 1002, the computing device may determine whether all assigned HTTP range requests have completed download on one of the two or more different available interfaces. In response to determining all assigned HTTP requests have not completed download on one of the two or more different available interfaces (i.e., determination block 1002=“No”), the computing device may continue to monitor the state of downloads in determination block 1002.

In response to determining that all assigned HTTP range requests have completed download on one of the two or more different available interfaces (i.e., determination block 1002=“Yes”), the computing device may perform the operations in block 902. In this manner, for each remaining download of a fragment of the series of fragments on the other of the two or more different available interfaces, the computing device may determine whether a download time is longer than a delay threshold, cancel the HTTP range request of the fragment in response to determining that the download time is longer than the delay threshold, and assign the HTTP range request of the fragment among the TCP connections established via the two or more different available interfaces with the server based at least in part on the determined link rate estimates in response to canceling the HTTP range request.

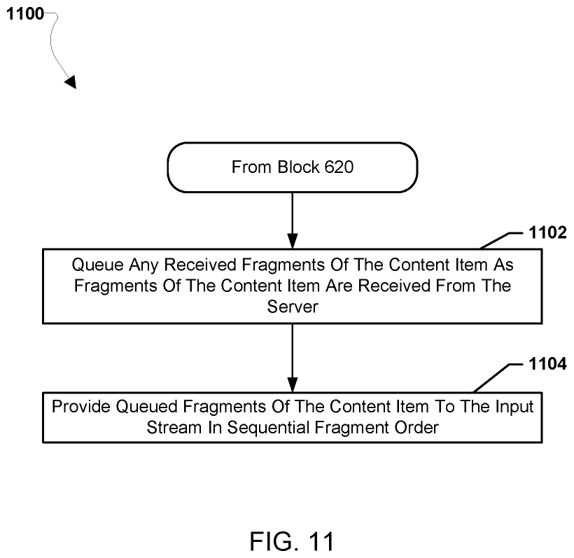

FIG. 11 illustrates an embodiment method 1100 for providing any received fragments of a content item to an input stream to an application (e.g., application 402). With reference to FIGS. 1-11, one or more operations of the method 1100 may be performed by an HTTP client (e.g., HTTP client 403) and/or a SCD module (e.g., SCD module 404), which are referred to generally as a computing device. In various embodiments, the operations of the method 1100 may be performed in conjunction with the operations of methods 600, 700, 800, 900, and/or 1000. In some embodiments, the operations of the method 1100 may be operations to provide any received fragments of the content item to the input stream to the application (e.g., application 402) performed in block 622 of the method 600.

In block 1102, the computing device may queue any received fragments of the content item as fragments of the content item are received from the server (e.g., 160, 406). For example, the SCD module 404 may queue any received fragments of the content item as fragments of the content item are received from the server.

In block 1104, the computing device may provide queued fragments of the content item to the input stream in sequential fragment order. For example, the SCD module 404 may provide queued fragments of the content item to the input stream in sequential fragment order.

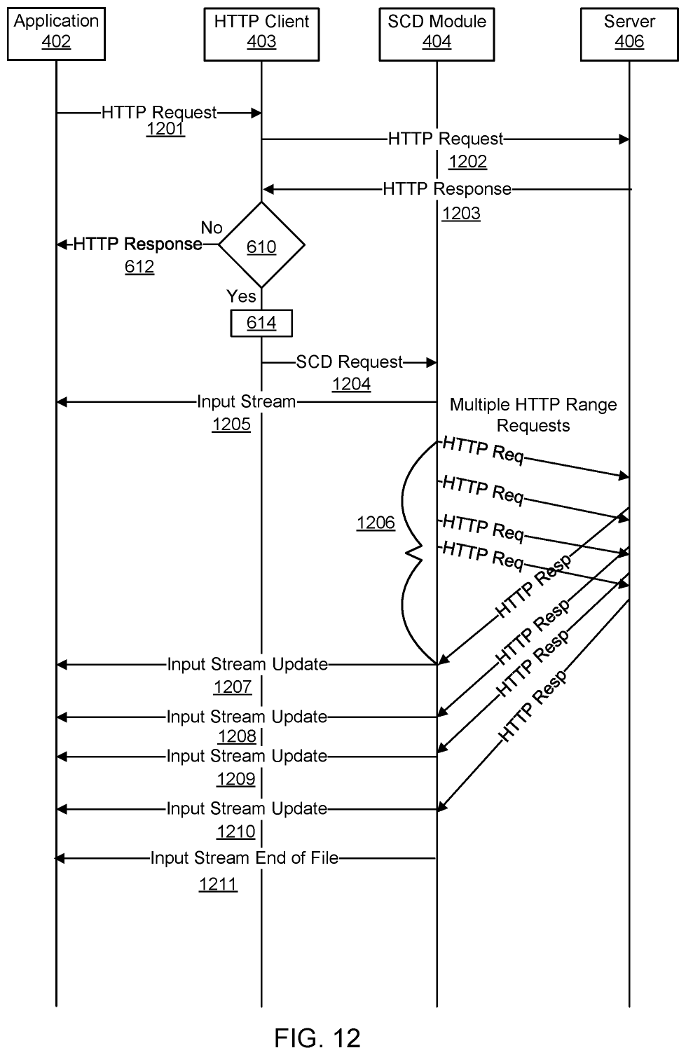

FIG. 12 is a call flow diagram illustrating example interactions between an application (e.g., 402), a HTTP client (e.g., 403), a SCD module (e.g., 404), and a server (e.g., 406) according to various embodiments, such as the various embodiment methods 600, 700, 800, 900, 1000, and/or 1100 described with reference to FIGS. 6-11.

With reference to FIGS. 1-12, in operation 1201 the application 402 may send a HTTP request to the HTTP client 403. The HTTP client 403 may initially open a TCP session and send an HTTP request (e.g., a HTTP or HTTPS request) in operation 1202 to the server 406. The server 406 may provide a HTTP response via the initial TCP connection in operation 1203 that indicates that the file content length and whether or not the server 406 supports HTTP range requests. As discussed, in determination block 610, the HTTP client 403 may verify whether the range request is supported by the web server and the content length is above a threshold. In response to determining that the content length is below the threshold or the server 406 does not support HTTP range requests, the HTTP client 403 may download the content via the initial TCP connection and send an HTTP response with the content to the application 402 in operation 612.

Based on file content length and support for range requests from the server 406, SCD may be engaged and the HTTP client 403 may close the initial TCP connection in block 614. The HTTP client 403 may hand over the request to the SCD module 404 in operation 1204 to trigger the SCD module 404 to download the file. The SCD module 404 may initiate an input stream with the application 402 in operation 1205. The SCD module 404 may makes multiple HTTP/HTTPS range requests simultaneously in operation 1206. These individual HTTP/HTTPS requests can go over any of the available interfaces as determined by SLA distribution. The received fragments in the HTTP responses from the server may be provided to the application 402 from the SCD module 404 in byte range sequence in input stream updates 1207, 1208, and 1209. Upon competition of download of all fragments for the content item, the SCD module 404 may indicate the input stream end of file is reached in operation 1211.

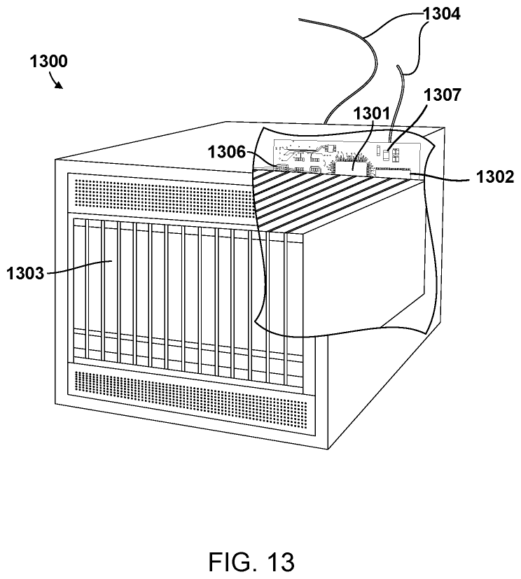

Various embodiments may be implemented on a variety of computing devices, an example of which is illustrated in FIG. 13 in the form of a server 1300. Such computing devices may include at least the components illustrated in FIG. 13. With reference to FIGS. 1-13, the server 1300 may typically include a processor 1301 coupled to volatile memory 1302 and a large capacity nonvolatile memory, such as a disk drive 1303. The server 1300 may also include a peripheral memory Access device such as a floppy disc drive, compact disc (CD) or digital video disc (DVD) drive 1306 coupled to the processor 1301. The server 1300 may also include network Access ports 1304 (or interfaces) coupled to the processor 1301 for establishing data connections with a network, such as the Internet and/or a local area network coupled to other system computers and servers. The server 1300 may include one or more antennas 1307 for sending and receiving electromagnetic radiation that may be connected to a wireless communication link. The server 1300 may include additional access ports, such as universal serial bus (USB), Firewire, Thunderbolt, and the like for coupling to peripherals, external memory, or other devices.

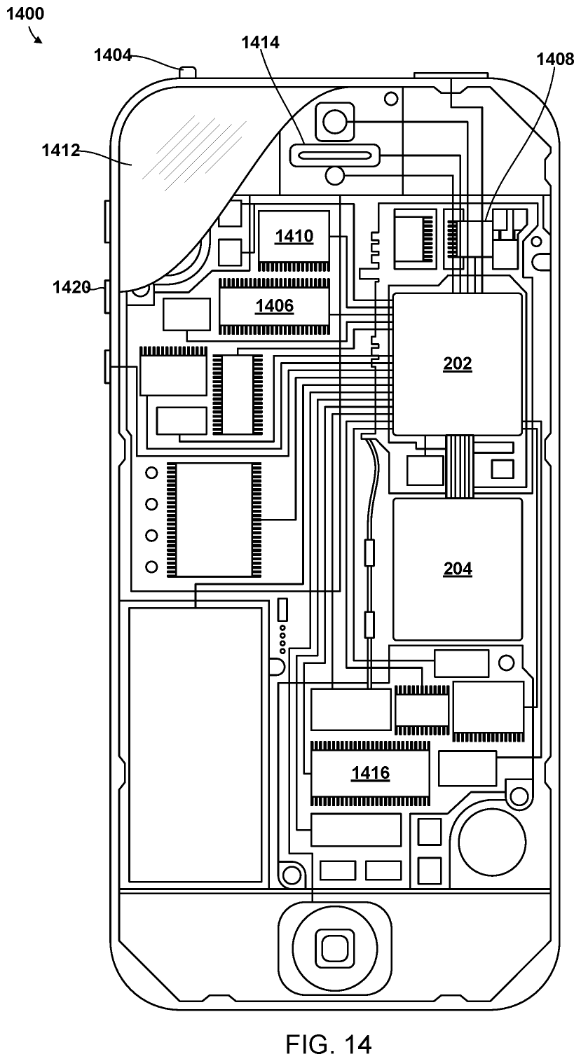

Various embodiments may be implemented on a variety of computing devices (e.g., the wireless device 120a-120e, 200, 320), an example of which is illustrated in FIG. 14 in the form of a smartphone 1400. With reference to FIGS. 1-14, the smartphone 1400 may include a first SOC 202 (e.g., a SOC-CPU) coupled to a second SOC 204 (e.g., a 5G capable SOC). The first and second SOCs 202, 204 may be coupled to internal memory 1406, 1416, a display 1412, and to a speaker 1414. Additionally, the smartphone 1400 may include an antenna 1404 for sending and receiving electromagnetic radiation that may be connected to a wireless data link and/or cellular telephone transceiver 1408 coupled to one or more processors in the first and/or second SOCs 202, 204. Smartphones 1400 typically also include menu selection buttons or rocker switches 1420 for receiving user inputs.

A typical smartphone 1400 also includes a sound encoding/decoding (CODEC) circuit 1410, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 1408 and CODEC 1410 may include a digital signal processor (DSP) circuit (not shown separately).

The processors of the computing device 1300 and the smart phone 1400 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SOC 204 dedicated to wireless communication functions and one processor within an SOC 202 dedicated to running other applications. Typically, software applications may be stored in the memory 1406, 1416 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, Function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple Access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the various methods may be substituted for or combined with one or more operations of the other various methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given Function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for supporting hypertext transfer protocol (HTTP) download of a content item by a computing device, comprising:
determining whether an HTTP response received from a server indicates that the server supports HTTP range requests and a content length of a content item to be downloaded is at, or above, a content length threshold, wherein the HTTP response is received from the server over an initial transmission control protocol (TCP) connection with the server and the HTTP response is in response to an HTTP request from an application sent to the server over the initial TCP connection; and
in response to determining that the HTTP response received from the server indicates that the server supports HTTP range requests and the content length of the content item to be downloaded is at, or above, the content length threshold:
closing the initial TCP connection;
establishing an input stream to the application;
partitioning the content item to be downloaded into a series of fragments, wherein each of the series of fragments is a non-overlapping byte range of the content to be downloaded such that the series of fragments fully covers the content item to be downloaded and each of the series of fragments has a fragment size smaller than the content length of the content item to be downloaded;
downloading the series of fragments from the server using HTTP range requests sent over TCP connections established via two or more different available interfaces with the server; and
providing any received fragments of the content item to the input stream to the application.

2. The method of claim 1, further comprising:
downloading the content item to be downloaded over the initial TCP connection in response to determining that the HTTP response received from the server indicates that the server does not support HTTP range requests or the content length of the content item to be downloaded is below the content length threshold.

3. The method of claim 1, wherein downloading the series of fragments from the server using HTTP range requests sent over TCP connections established via two or more different available interfaces with the server comprises:
generating an HTTP range request for each of the series of fragments; and
sending the HTTP range requests in sequential fragment order over TCP connections established via two or more different available interfaces with the server.

4. The method of claim 3, wherein sending the HTTP range requests in sequential fragment order over TCP connections established via two or more different available interfaces with the server comprises:
determining link rate estimates for each of the two or more different available interfaces with the server;
apportioning assignment of the HTTP range requests among the TCP connections established via the two or more different available interfaces with the server based at least in part on the determined link rate estimates; and
sending each of the HTTP range requests over its respective assigned TCP connection and corresponding one of the two or more different available interfaces to the server.

5. The method of claim 4, wherein generating the HTTP range request for each of the series of fragments comprises generating the HTTP range request for each of the series of fragments in sequential fragment order.

6. The method of claim 5, further comprising determining whether memory resources are available for downloading a next fragment of the series of fragments,
wherein generating the HTTP range request for each of the series of fragments in sequential fragment order comprises generating the HTTP range request for each of the series of fragments in sequential fragment order in response to determining that memory resources are available for downloading a next fragment of the series of fragments.

7. The method of claim 4, further comprising, for each download of a fragment of the series of fragments:
determining whether a download time is longer than a delay threshold;
canceling the HTTP range request of the fragment in response to determining that the download time is longer than the delay threshold; and
assigning the HTTP range request of the fragment among the TCP connections established via the two or more different available interfaces with the server based at least in part on the determined link rate estimates in response to canceling the HTTP range request.

8. The method of claim 4, further comprising:
determining whether all assigned HTTP range requests have completed download on one of the two or more different available interfaces; and
in response to determining that all assigned HTTP range requests have completed download on one of the two or more different available interfaces, for each remaining download of a fragment of the series of fragments on the other of the two or more different available interfaces:
determining whether a download time is longer than a delay threshold;
canceling the HTTP range request of the fragment in response to determining that the download time is longer than the delay threshold; and
assigning the HTTP range request of the fragment among the TCP connections established via the two or more different available interfaces with the server based at least in part on the determined link rate estimates in response to canceling the HTTP range request.

9. The method of claim 4, wherein the apportionment of assignments of the HTTP range requests among the TCP connections established via the two or more different available interfaces with the server based at least in part on the determined link rate is a probabilistic distribution calculated based on the determined link rate.

10. The method of claim 1, wherein providing any received fragments of the content item to the input stream to the application comprises:
queuing any received fragments of the content item as fragments of the content item are received from the server; and
providing queued fragments of the content item to the input stream in sequential fragment order.

11. The method of claim 1, wherein each of the two or more different available interfaces are different network connections established by the computing device.

12. The method of claim 1, wherein the two or more different available interfaces comprises at least one Wi-Fi connection and at least one cellular connection.

13. A computing device, comprising:
a transceiver; and
a processor coupled to the transceiver and configured with processor-executable instructions to:
determine whether an HTTP response received from a server indicates that the server supports HTTP range requests and a content length of a content item to be downloaded is at, or above, a content length threshold, wherein the HTTP response is received from the server over an initial transmission control protocol (TCP) connection with the server and the HTTP response is in response to an HTTP request from an application sent to the server over the initial TCP connection; and
in response to determining that the HTTP response received from the server indicates that the server supports HTTP range requests and the content length of the content item to be downloaded is at, or above, the content length threshold:
close the initial TCP connection;
establish an input stream to the application;
partition the content item to be downloaded into a series of fragments, wherein each of the series of fragments is a non-overlapping byte range of the content to be downloaded such that the series of fragments fully covers the content item to be downloaded and each of the series of fragments has a fragment size smaller than the content length of the content item to be downloaded;
download the series of fragments from the server using HTTP range requests sent over TCP connections established via two or more different available interfaces with the server; and
provide any received fragments of the content item to the input stream to the application.

14. The computing device of claim 13, wherein the processor is further configured with processor-executable instructions to:
download the content item to be downloaded over the initial TCP connection in response to determining that the HTTP response received from the server indicates that the server does not support HTTP range requests or the content length of the content item to be downloaded is below the content length threshold.

15. The computing device of claim 13, wherein the processor is further configured with processor-executable instructions to download the series of fragments from the server using HTTP range requests sent over TCP connections established via two or more different available interfaces with the server by:
generating an HTTP range request for each of the series of fragments; and
sending the HTTP range requests in sequential fragment order over TCP connections established via two or more different available interfaces with the server.

16. The computing device of claim 15, wherein the processor is further configured with processor-executable instructions to send the HTTP range requests in sequential fragment order over TCP connections established via two or more different available interfaces with the server by:
determining link rate estimates for each of the two or more different available interfaces with the server;
apportioning assignment of the HTTP range requests among the TCP connections established via the two or more different available interfaces with the server based at least in part on the determined link rate estimates; and
sending each of the HTTP range requests over its respective assigned TCP connection and corresponding one of the two or more different available interfaces to the server.

17. The computing device of claim 16, wherein the processor is further configured with processor-executable instructions to generate the HTTP range request for each of the series of fragments in sequential fragment order.

18. The computing device of claim 17, wherein the processor is further configured with processor-executable instructions to determine whether memory resources are available for downloading a next fragment of the series of fragments,
wherein the processor is further configured with processor-executable instructions to generate the HTTP range request for each of the series of fragments in sequential fragment order in response to determining that memory resources are available for downloading a next fragment of the series of fragments.

19. The computing device of claim 16, wherein the processor is further configured with processor-executable instructions to:
determine, for each download of a fragment of the series of fragments, whether a download time is longer than a delay threshold;
cancel the HTTP range request of the fragment in response to determining that the download time is longer than the delay threshold; and
assign the HTTP range request of the fragment among the TCP connections established via the two or more different available interfaces with the server based at least in part on the determined link rate estimates in response to canceling the HTTP range request.

20. The computing device of claim 16, wherein the processor is further configured with processor-executable instructions to:
determine whether all assigned HTTP range requests have completed download on one of the two or more different available interfaces; and
in response to determining that all assigned HTTP range requests have completed download on one of the two or more different available interfaces, for each remaining download of a fragment of the series of fragments on the other of the two or more different available interfaces:
determine whether a download time is longer than a delay threshold;
cancel the HTTP range request of the fragment in response to determining that the download time is longer than the delay threshold; and
assign the HTTP range request of the fragment among the TCP connections established via the two or more different available interfaces with the server based at least in part on the determined link rate estimates in response to canceling the HTTP range request.

21. The computing device of claim 16, wherein the apportionment of assignments of the HTTP range requests among the TCP connections established via the two or more different available interfaces with the server based at least in part on the determined link rate is a probabilistic distribution calculated based on the determined link rate.

22. The computing device of claim 13, wherein the processor is further configured with processor-executable instructions to provide any received fragments of the content item to the input stream to the application by:
queuing any received fragments of the content item as fragments of the content item are received from the server; and
providing queued fragments of the content item to the input stream in sequential fragment order.

23. The computing device of claim 13, wherein each of the two or more different available interfaces are different network connections established by the processor.

24. The computing device of claim 13, wherein the two or more different available interfaces comprises at least one Wi-Fi connection and at least one cellular connection.

25. A communication processing device for use in a computing device, comprising a processor is configured with processor-executable instructions to:
determine whether an HTTP response received from a server indicates that the server supports HTTP range requests and a content length of a content item to be downloaded is at, or above, a content length threshold, wherein the HTTP response is received from the server over an initial transmission control protocol (TCP) connection with the server and the HTTP response is in response to an HTTP request from an application sent to the server over the initial TCP connection; and
in response to determining that the HTTP response received from the server indicates that the server supports HTTP range requests and the content length of the content item to be downloaded is at, or above, the content length threshold:
close the initial TCP connection;
establish an input stream to the application;
partition the content item to be downloaded into a series of fragments, wherein each of the series of fragments is a non-overlapping byte range of the content to be downloaded such that the series of fragments fully covers the content item to be downloaded and each of the series of fragments has a fragment size smaller than the content length of the content item to be downloaded;
download the series of fragments from the server using HTTP range requests sent over TCP connections established via two or more different available interfaces with the server; and
provide any received fragments of the content item to the input stream to the application.

26. The communication processing device of claim 25, wherein the processor is further configured with processor-executable instructions to download the series of fragments from the server using HTTP range requests sent over TCP connections established via two or more different available interfaces with the server by:
generating an HTTP range request for each of the series of fragments; and
sending the HTTP range requests in sequential fragment order over TCP connections established via two or more different available interfaces with the server.

27. The communication processing device of claim 26, wherein the processor is further configured with processor-executable instructions to send the HTTP range requests in sequential fragment order over TCP connections established via two or more different available interfaces with the server by:
determining link rate estimates for each of the two or more different available interfaces with the server;
apportioning assignment of the HTTP range requests among the TCP connections established via the two or more different available interfaces with the server based at least in part on the determined link rate estimates; and
sending each of the HTTP range requests over its respective assigned TCP connection and corresponding one of the two or more different available interfaces to the server.

28. The communication processing device of claim 27, wherein the processor is further configured with processor-executable instructions to:
determine, for each download of a fragment of the series of fragments, whether a download time is longer than a delay threshold;
cancel the HTTP range request of the fragment in response to determining that the download time is longer than the delay threshold; and
assign the HTTP range request of the fragment among the TCP connections established via the two or more different available interfaces with the server based at least in part on the determined link rate estimates in response to canceling the HTTP range request.

29. The communication processing device of claim 27, wherein the processor is further configured with processor-executable instructions to:
determine whether all assigned HTTP range requests have completed download on one of the two or more different available interfaces; and
in response to determining that all assigned HTTP range requests have completed download on one of the two or more different available interfaces, for each remaining download of a fragment of the series of fragments on the other of the two or more different available interfaces:
determine whether a download time is longer than a delay threshold;
cancel the HTTP range request of the fragment in response to determining that the download time is longer than the delay threshold; and
assign the HTTP range request of the fragment among the TCP connections established via the two or more different available interfaces with the server based at least in part on the determined link rate estimates in response to canceling the HTTP range request.

30. A non-transitory processor-readable medium having stored comprising:
determining whether an HTTP response received from a server indicates that the server supports HTTP range requests and a content length of a content item to be downloaded is at, or above, a content length threshold, wherein the HTTP response is received from the server over an initial transmission control protocol (TCP) connection with the server and the HTTP response is in response to an HTTP request from an application sent to the server over the initial TCP connection; and
in response to determining that the HTTP response received from the server indicates that the server supports HTTP range requests and the content length of the content item to be downloaded is at, or above, the content length threshold:
closing the initial TCP connection;
establishing an input stream to the application;
partitioning the content item to be downloaded into a series of fragments, wherein each of the series of fragments is a non-overlapping byte range of the content to be downloaded such that the series of fragments fully covers the content item to be downloaded and each of the series of fragments has a fragment size smaller than the content length of the content item to be downloaded;
downloading the series of fragments from the server using HTTP range requests sent over TCP connections established via two or more different available interfaces with the server; and
providing any received fragments of the content item to the input stream to the application.
